(19) United States
(12) Patent Application Publication
(10) Pub. No.: US 2021/0130917 A1
(43) Pub. Date: May 6, 2021

(54) ALLOY RIBBON PIECE AND METHOD FOR MANUFACTURING THE SAME

(71) Applicant: TOYOTA JIDOSHA KABUSHIKI KAISHA, Toyota-shi (JP)

(72) Inventor: Hideki MANABE, Toyota-shi (JP)

(73) Assignee: TOYOTA JIDOSHA KABUSHIKI KAISHA, Toyota-shi (JP)

(21) Appl. No.: 17/036,618

(22) Filed: Sep. 29, 2020

(30) Foreign Application Priority Data
Oct. 30, 2019 (JP) 2019-197687

(51) Int. Cl. C21D 8/02; C22C 45/00; C21D 8/00; C21D 9/52

(52) U.S. Cl. CPC C21D 8/0205; C21D 9/52; C21D 8/005; C22C 45/008

(57) ABSTRACT

There are provided an alloy ribbon piece that ensures an increased dimensional accuracy and a method for manufacturing the same. An alloy ribbon piece of the present disclosure includes a crystallized portion excluding an edge portion. The crystallized portion includes a nanocrystalline alloy obtained by crystallizing an amorphous alloy, and the edge portion includes an amorphous alloy.

### CROSS REFERENCE TO RELATED APPLICATIONS

The present application claims priority from Japanese patent application JP 2019-197687 filed on Oct. 30, 2019, the entire content of which is hereby incorporated by reference into this application.

### BACKGROUND

### Technical Field

The present disclosure relates to an alloy ribbon piece including a nanocrystalline alloy and a method for manufacturing the same.

### Description of Related Art

Conventionally, an amorphous alloy ribbon piece including an amorphous alloy has been used for, for example, a motor core. Since a nanocrystalline alloy ribbon piece including a nanocrystalline alloy obtained by crystallizing the amorphous alloy is a soft magnetic material that can provide a high saturation magnetic flux density and a low coercivity at the same time, recently, the nanocrystalline alloy ribbon piece has been used for the motor core and the like.

As a method for manufacturing the nanocrystalline alloy ribbon piece, there has been known a method wherein while plates sandwich an amorphous alloy ribbon piece punched into a predetermined shape used for the motor core and the like from a continuous amorphous alloy ribbon manufactured by a method such as a single roll method or a twin roll method, the plates heat the amorphous alloy ribbon piece to crystallize the amorphous alloy ribbon piece (JP 2017-141508 A). There has been also known a method that after manufacturing a ribbon member for presswork by forming a resin layer wherein suppresses cracking during the presswork on a surface of a nanocrystalline alloy ribbon after manufacturing the nanocrystalline alloy ribbon obtained by heating and crystallizing a continuous amorphous alloy ribbon, the presswork is performed to punch out a nanocrystalline alloy ribbon piece in a predetermined shape from the ribbon member (JP 2003-163486 A).

### SUMMARY

In the method for manufacturing the nanocrystalline alloy ribbon piece described in JP 2017-141508 A, the nanocrystalline alloy ribbon piece is manufactured by heating and crystallizing the amorphous alloy ribbon piece punched into the predetermined shape used for the motor core and the like from the amorphous alloy ribbon. The alloy ribbon piece shrinks during the crystallization, and in addition, its shrinkage of the alloy ribbon piece may vary by sites due to, for example, uneven distribution of distortion. In view of this, the nanocrystalline alloy ribbon piece sometimes has a low dimensional accuracy. Furthermore, when, after a plurality of the nanocrystalline alloy ribbon pieces are manufactured, for example, a motor core in which they are laminated is manufactured, there is a possibility of a significantly lowered dimensional accuracy of the motor core and the like caused by all of low dimensional accuracies of the plurality of those nanocrystalline alloy ribbon pieces. As a result, a gap between a stator and a rotor of a motor and the like cannot be controlled with a high accuracy, thereby making it difficult to wind a coil around a stator core with an expected space factor. In order to deal with these problems, finish processing may be employed, but a manufacturing cost is increased in such a case.

As a method to suppress the dimensional accuracy of such an alloy ribbon piece from lowering, it is possible to consider a method for manufacturing a nanocrystalline alloy ribbon piece by partly punching out a predetermined shape used for the motor core and the like from a nanocrystalline alloy ribbon after manufacturing the nanocrystalline alloy ribbon obtained by heating and crystallizing a continuous amorphous alloy ribbon. With this method, the nanocrystalline alloy ribbon piece is punched out from the nanocrystalline alloy ribbon that has already been crystallized, and therefore, the shrinking caused by the crystallization of the alloy ribbon piece does not occur. Accordingly, the dimensional accuracy of the nanocrystalline alloy ribbon piece can be suppressed from lowering. However, the nanocrystalline alloy ribbon is significantly embrittled compared with an amorphous alloy ribbon, and therefore, a damage, such as cracking, may occur when the nanocrystalline alloy ribbon piece is punched out from the nanocrystalline alloy ribbon. In the manufacturing method described in JP 2003-163486 A, in order to deal with such a problem, after manufacturing the ribbon member for presswork by forming the resin layer, which suppresses cracking during the presswork, on the surface of the nanocrystalline alloy ribbon, the presswork is performed to punch out the nanocrystalline alloy ribbon piece from the ribbon member. However, it is necessary to form the extra resin layer on the surface of the nanocrystalline alloy ribbon, and the manufacturing cost is increased.

The present disclosure provides an alloy ribbon piece including a nanocrystalline alloy and a method for manufacturing the same, and the alloy ribbon piece that ensures an increased dimensional accuracy and the method for manufacturing the same.

To solve the above-described problem, an alloy ribbon piece of the present disclosure comprises: a crystallized portion excluding an edge portion, the crystallized portion including a nanocrystalline alloy obtained by crystallizing an amorphous alloy; and the edge portion that includes an amorphous alloy.

The present disclosure ensures an increased dimensional accuracy of the alloy ribbon piece including the nanocrystalline alloy.

In the above-described disclosure, the edge portion may have a width of 1 mm or more. This is because a damage, such as cracking, can be effectively suppressed.

To solve the above-described problem, a method for manufacturing an alloy ribbon piece of the present disclosure comprises: preparing an alloy ribbon including an amorphous alloy; crystallizing a crystallization scheduled portion (portion to be crystallized) by heating the crystallization scheduled portion to a temperature range equal to or more than a crystallization starting temperature, the crystallization scheduled portion excluding an edge portion in a punching scheduled portion (portion to be punched) of the alloy ribbon piece in the alloy ribbon; and forming the alloy ribbon piece by punching out the punching scheduled portion from the alloy ribbon after the crystallizing.

The present disclosure ensures an increased dimensional accuracy of the alloy ribbon piece including the nanocrystalline alloy.

In the above-described disclosure, the edge portion may have a width of 1 mm or more. This is because a damage, such as cracking, can be effectively suppressed.

### Effect

The present disclosure ensures an increased dimensional accuracy of the alloy ribbon piece including the nanocrystalline alloy.

### BRIEF DESCRIPTION OF THE DRAWINGS

FIG. 1 is a schematic plan view illustrating an exemplary alloy ribbon piece of an embodiment according to the disclosure; FIG. 2 is a flowchart of an exemplary method for manufacturing the alloy ribbon piece of the embodiment according to the disclosure:

FIG. 3A and FIG. 3B are schematic process plan views of the exemplary method for manufacturing the alloy ribbon piece of the embodiment according to the disclosure;

FIG. 4C and FIG. 4D are schematic process plan views of the exemplary method for manufacturing the alloy ribbon piece of the embodiment according to the disclosure;

FIG. 5A and FIG. 5B are schematic process cross-sectional views illustrating cross-sectional surfaces taken along the lines A-A′ in FIG. 3A and FIG. 3B, respectively;

FIG. 6C and FIG. 6D are schematic process cross-sectional views illustrating cross-sectional surfaces taken along the lines A-A′ in FIG. 4C and FIG. 4D, respectively;

FIG. 7A and FIG. 7B are schematic process plan views of a main part in another exemplary method for manufacturing the alloy ribbon piece of the embodiment according to the disclosure; and

FIG. 8A is a schematic plan view illustrating a heat treatment step in an experiment of a method for manufacturing an alloy ribbon, and FIG. 8B is a schematic cross-sectional view illustrating a cross-sectional surface taken along the line A-A′ in FIG. 8A.

### DETAILED DESCRIPTION OF THE EMBODIMENTS

A. Alloy Ribbon Piece

The following describes an embodiment according to an alloy ribbon piece of the disclosure.

The alloy ribbon piece of the embodiment according to the disclosure has a crystallized portion excluding an edge portion. The crystallized portion includes a nanocrystalline alloy obtained by crystallizing an amorphous alloy, and the edge portion includes an amorphous alloy.

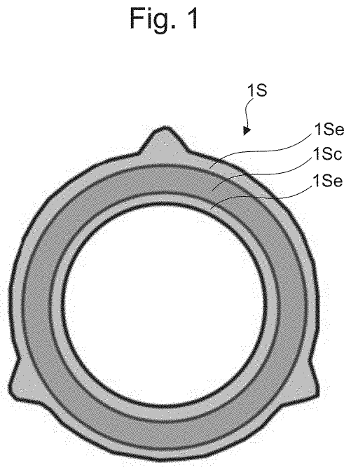

First, an exemplary alloy ribbon piece of the embodiment according to the disclosure will be described. Here, FIG. 1 is a schematic plan view illustrating an exemplary alloy ribbon piece of the embodiment according to the disclosure.

As illustrated in FIG. 1, an alloy ribbon piece 1S of the example is an alloy ribbon piece for a stator core of a motor, and can manufacture the stator core by being laminated. The alloy ribbon piece 1S has a crystallized portion 1Sc excluding edge portions 1Se. The crystallized portion 1Sc includes a nanocrystalline alloy obtained by crystallizing an amorphous alloy, and the edge portions 1Se includes an amorphous alloy.

While the alloy ribbon piece 1S of the example has the crystallized portion 1Sc as a crystalline alloy ribbon piece including the nanocrystalline alloy, the edge portions 1Se include the amorphous alloy that is not as brittle as the nanocrystalline alloy. In view of this, for example, in a case where the edge portions 1Se of the alloy ribbon piece 1S are brought into contact with an assembling facility for the stator core for positioning when the alloy ribbon piece 1S is conveyed to and arranged in the facility, a damage, such as cracking, of the alloy ribbon piece 1S caused by an impact and the like at the time of the contact can be suppressed.

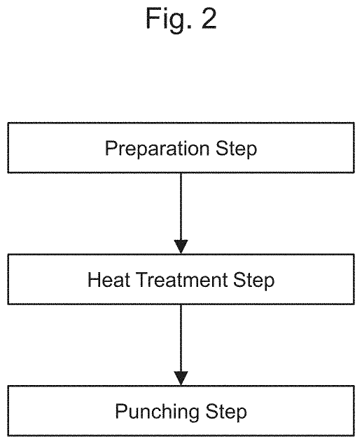

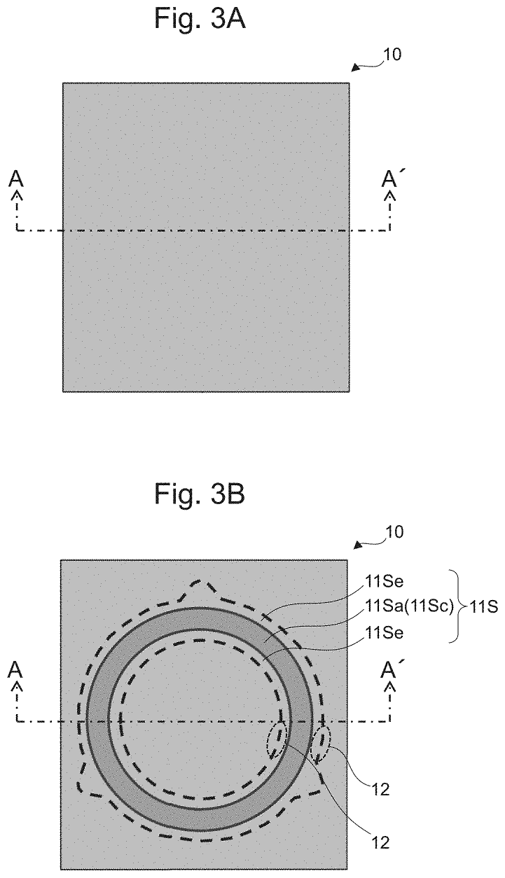

Furthermore, since the crystallized portion 1Sc includes the nanocrystalline alloy and the edge portions 1Se include the amorphous alloy, for example, with a manufacturing method illustrated in FIG. 3A to FIG. 4D and FIG. 5A to FIG. 6D described below, the alloy ribbon piece 1S of the example can be manufactured by punching out a portion to be punched 11S of a crystallized alloy ribbon piece from an alloy ribbon 10 without causing the damage, such as cracking, which causes a problem in quality. When being manufactured by such a manufacturing method, the alloy ribbon piece S does not have a shrinkage caused by the crystallization unlike a nanocrystalline alloy ribbon piece manufactured by heating and crystallizing the alloy ribbon piece, which is punched out from an alloy ribbon before the crystallization. Accordingly, a dimensional accuracy of the alloy ribbon piece 1S including the nanocrystalline alloy can be increased.

Therefore, the alloy ribbon piece of the embodiment can suppress the damage of the alloy ribbon piece including the nanocrystalline alloy like the alloy ribbon piece 1S of the example. Furthermore, the alloy ribbon piece of the embodiment can increase the dimensional accuracy of the alloy ribbon piece including the nanocrystalline alloy when being manufactured by a manufacturing method described in the item of “B. Method for Manufacturing Alloy Ribbon Piece” described later. This ensures manufacturing, for example, a motor core with a high dimensional accuracy only with punching accuracy and lamination accuracy and ensures completing the manufacturing process without finish processing, thus ensuring a reduced manufacturing cost. As a result, a problem of failing to control the gap between the stator and the rotor of the motor and the like with a high accuracy and a problem of a difficulty in winding a coil around the stator core with an expected space factor can be suppressed at a low manufacturing cost.

Subsequently, for the alloy ribbon piece of the embodiment, each configuration will be described in details.

The alloy ribbon piece of the embodiment has a crystallized portion excluding an edge portion. The crystallized portion includes a nanocrystalline alloy obtained by crystallizing an amorphous alloy, and the edge portion includes an amorphous alloy.

Here, the “edge portion” indicates a portion that extends inward from an outer periphery with a predetermined width in the alloy ribbon piece. The “crystallized portion” indicates a portion excluding the edge portion in the alloy ribbon piece.

While the width of the edge portion is not specifically limited, for example, it is 1 mm or more in some embodiments. This is because the damage, such as cracking, can be effectively suppressed when it is equal to or more than this lower limit. In some embodiments, the width of the edge portion is as small as possible. This is because increasing a proportion of the crystallized portion including the nanocrystalline alloy ensures improved magnetic properties of the alloy ribbon piece. This is also because, when the alloy ribbon piece is used for the stator core or the rotor core, a saturation magnetic flux density in a region neighboring the rotor core of the stator core or a region neighboring the stator core of the rotor core can be increased, thereby ensuring an improved performance of the motor and the like. Here, the “width of edge portion” indicates a length of the edge portion in a direction perpendicular to the outer periphery of the alloy ribbon piece.

While a plane size and a shape of the alloy ribbon piece are not specifically limited, for example, this includes a common plane size and shape of a ribbon piece that configures the stator core or the rotor core in the motor, or a ribbon piece obtained by further dividing a ribbon piece that configures the stator core in the circumferential direction. Since the alloy ribbon piece has a thickness that is the same as a thickness of the alloy ribbon described in the item of “B. Method for Manufacturing Alloy Ribbon Piece 1. Preparation Step” described later, the description is omitted here.

Since the nanocrystalline alloy that configures the crystallized portion is the same as the nanocrystalline alloy described in the item “B. Method for Manufacturing Alloy Ribbon Piece 2. Heat Treatment Step” described later, the description is omitted here. Since the amorphous alloy that configures the edge portion is the same as the amorphous alloy described in the item of “B. Method for Manufacturing Alloy Ribbon Piece 1. Preparation Step” described later, the description is omitted here.

While the alloy ribbon piece of the embodiment is not specifically limited, it is one that is manufactured by the manufacturing method described in the item “B. Method for Manufacturing Alloy Ribbon Piece” described later in some embodiments. This is because the dimensional accuracy of the alloy ribbon piece including the nanocrystalline alloy can be increased.

B. Method for Manufacturing Alloy Ribbon Piece

The following describes the embodiment according to the method for manufacturing the alloy ribbon piece of the disclosure.

The method for manufacturing an alloy ribbon piece of the embodiment comprises: a preparation step of preparing an alloy ribbon including an amorphous alloy; a heat treatment step of crystallizing a crystallization scheduled portion (portion to be crystallized) by heating the crystallization scheduled portion to a temperature range equal to or more than a crystallization starting temperature, the crystallization scheduled portion excluding an edge portion in a punching scheduled portion (portion to be punched) of the alloy ribbon piece in the alloy ribbon; and a punching step of forming the alloy ribbon piece by punching out the punching scheduled portion from the alloy ribbon after the heat treatment step.

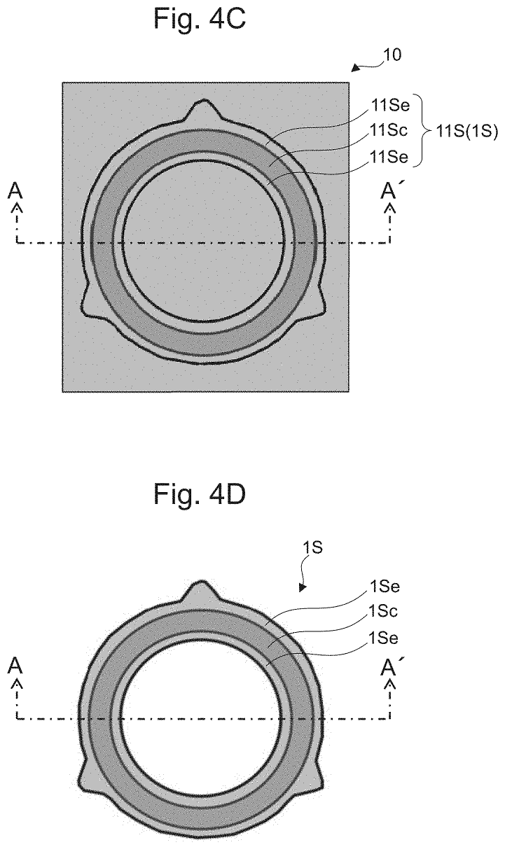

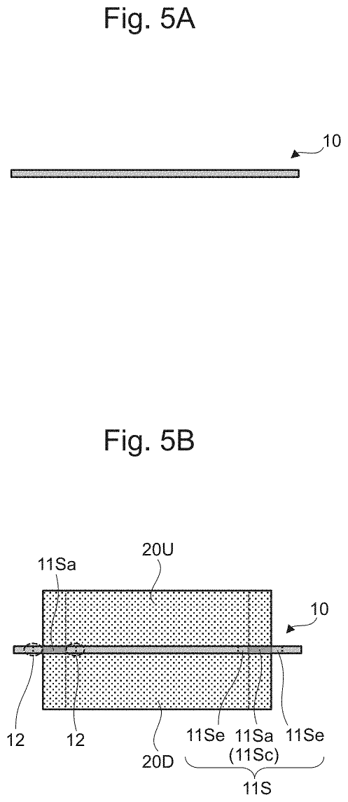

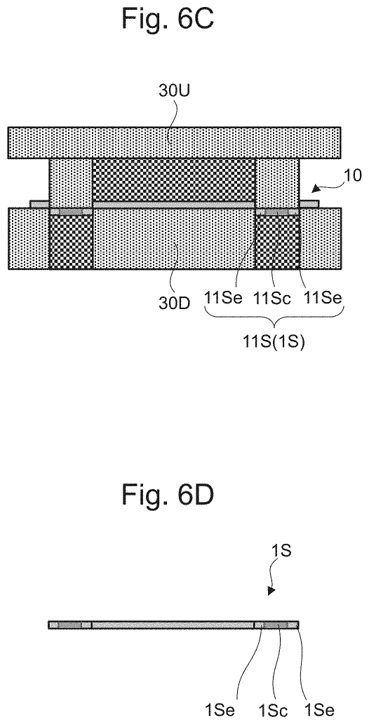

First, an exemplary method for manufacturing the alloy ribbon piece of the embodiment according to the disclosure will be described. Here, FIG. 2 is a flowchart of the exemplary method for manufacturing the alloy ribbon piece of the embodiment according to the disclosure. FIG. 3A to FIG. 4D are schematic process plan views of the exemplary method for manufacturing the alloy ribbon piece of the embodiment according to the disclosure. FIG. 5A to FIG. 6D are schematic process cross-sectional views illustrating cross-sectional surfaces taken along the lines A-A′ in respective FIG. 3A to FIG. 4D.

In the method for manufacturing the alloy ribbon piece of the example, first, as illustrated in FIG. 3A and FIG. 5A, the continuous alloy ribbon 10 including an amorphous alloy is prepared (the preparation step).

Next, as illustrated in FIG. 3B and FIG. 5B, in a state where the alloy ribbon 10 is placed in an atmosphere at normal temperature, a portion to be crystallized (crystallization scheduled portion) 11Sa excluding edge portions 11Se in a portion to be punched (punching scheduled portion) 11S of the alloy ribbon piece for a stator core in the alloy ribbon 10 is sandwiched by an upper heating die 20U and a lower heating die 20D (illustrated only in FIG. 5B) made of copper and heated to a high temperature to heat the portion to be crystallized 11Sa to a temperature range equal to or more than a crystallization starting temperature to crystallize the portion to be crystallized 11Sa. Thus, a crystallized portion 11Sc including the nanocrystalline alloy is provided (the heat treatment step). In this respect, the thin alloy ribbon 10 efficiently radiates heat into the atmosphere from processing portions 12 including the edge portions 11Se of the portion to be punched 11S. In view of this, the processing portions 12 are not crystallized to the extent to cause an embrittlement that could cause the damage, such as cracking, which causes a problem in quality when punched.

Next, as illustrated in FIG. 4C and FIG. 6C, the alloy ribbon 10 is sandwiched by an upper pressing die 30U and a lower pressing die 30D (illustrated only in FIG. 6C) and a presswork is performed on the alloy ribbon 10 to punch out the portion to be punched 11S of the alloy ribbon piece for the stator core from the alloy ribbon 10. Thus, the alloy ribbon piece 1S for the stator core is formed (the punching step). In view of this, as illustrated in FIG. 4D and FIG. 6D, the alloy ribbon piece 1S for the stator core having the edge portions 1Se including the amorphous alloy and the crystallized portion 1Sc, which excludes the edge portions 1Se, including the nanocrystalline alloy can be manufactured without causing the damage, such as cracking, winch causes a problem in quality.

In the method for manufacturing the alloy ribbon piece of the example, a shrinkage caused by the crystallization of the alloy ribbon piece does not occur unlike a method for manufacturing a nanocrystalline alloy ribbon piece by heating and crystallizing an alloy ribbon piece, which is punched out from an alloy ribbon before the crystallization. Accordingly, the dimensional accuracy of the alloy ribbon piece 1S including the nanocrystalline alloy can be increased.

Furthermore, the alloy ribbon piece 1S manufactured by the manufacturing method of the example has the edge portions 1Se including the amorphous alloy that is not as brittle as the nanocrystalline alloy. In view of this, for example, in a case where the edge portions 1Se of the alloy ribbon piece 1S are brought into contact with an assembling facility for the stator core for positioning when the alloy ribbon piece 1S is conveyed to and arranged in the facility, the damage, such as cracking, of the alloy ribbon piece 1S caused by the impact and the like at the time of the contact can be suppressed.

Therefore, with the method for manufacturing the alloy ribbon piece of the embodiment, the dimensional accuracy of the alloy ribbon piece including the nanocrystalline alloy can be increased like the method for manufacturing the alloy ribbon piece of the example. This ensures manufacturing, for example, a motor core with a high dimensional accuracy only with punching accuracy and lamination accuracy and ensures completing the manufacturing process without finish processing, thus ensuring a reduced manufacturing cost. As a result, a problem of failing to control a gap between a stator and a rotor of a motor and the like with a high accuracy and a problem of a difficulty in winding a coil around a stator core with an expected space factor can be suppressed at a low manufacturing cost. Furthermore, the damage of the alloy ribbon piece including the nanocrystalline alloy can be suppressed.

Subsequently, for the method for manufacturing the alloy ribbon piece of the embodiment, each condition is described in detail.

1. Preparation Step

In the preparation step, the alloy ribbon including the amorphous alloy is prepared.

The alloy ribbon is not specifically limited as long as it includes an amorphous alloy, and, for example, it is an amorphous alloy ribbon in a continuous sheet shape manufactured in a common method, such as a single-roll process or a twin-roll process.

The amorphous alloy that configures the alloy ribbon is not specifically limited, and, this includes, for example, a Fe-based amorphous alloy, a Ni-based amorphous alloy, and a Co-based amorphous alloy. Among them, the Fe-based amorphous alloy and the like is used in some embodiments. Here, the “Fe-based amorphous alloy” means those containing Fe as the main component, and impurities, such as B, Si, C, P, Cu, Nb, and Zr. The “Ni-based amorphous alloy” means those containing Ni as the main component. The “Co-based amorphous alloy” means those containing Co as the main component.

The Fe-based amorphous alloy may have, for example, a content of Fe in a range of 84 atomic % or more, and among all, has more content of Fe in some embodiments. This is because a magnetic-flux density of the nanocrystalline alloy obtained by crystallizing the amorphous alloy varies depending on the content of Fe.

While the thickness of the alloy ribbon is not specifically limited, it differs depending on a constituent material and the like, and when the constituent material is the Fe-based amorphous alloy, for example, it is in a range of 10 μm or more to 100 μm or less, and among them, it is in a range of 20 μm or more to 50 μm or less in some embodiments. This is because the thickness equal to or more than the lower limit of these ranges ensures suppressing the manufacturing cost from increasing caused by the increased number of laminations in a laminated body of the alloy ribbon used for the motor core, the increased number of punching, and the increased time for lamination. Note that the thinner the thickness of the alloy ribbon is, the more an eddy-current loss of the motor core that uses the laminated body of the alloy ribbon can be reduced, thereby being advantageous in performance. It is also because the thickness equal to or less than the upper limit of these ranges ensures effectively suppressing the processing portion from being crystallized, as the processing portion including the edge portion of the portion to be punched effectively radiates heat when the portion to be crystallized of the portion to be punched is crystallized by heating.

2. Heat Treatment Step

In the heat treatment step, the portion to be crystallized excluding the edge portion among the portion to be punched of the alloy ribbon piece in the alloy ribbon is crystallized by heating the portion to be crystallized to the temperature range equal to or more than the crystallization starting temperature. In the heat treatment step, the processing portion including the edge portion of the portion to be punched of the alloy ribbon piece may be crystallized as long as a crystallization rate is such that the crystallization rate does not cause an embrittlement that could cause the damage, such as cracking, which causes a problem in quality when punched, when the portion to be crystallized excluding the edge portion in the portion to be punched of the alloy ribbon piece is crystallized by heating. Meanwhile, the processing portion including the edge portion of the portion to be punched of the alloy ribbon piece is not crystallized in some embodiments.

Here, the “portion to be punched” indicates a region punched out from the alloy ribbon in the punching step described later to become an alloy ribbon piece. The “edge portion of portion to be punched” indicates a portion that extends inward from the outer periphery with a predetermined width in the portion to be punched. The “portion to be crystallized of portion to be punched” indicates a portion excluding the edge portion in the portion to be punched. Furthermore, the “processing portion including edge portion of portion to be punched” indicates a portion including at least the edge portion of the portion to be punched in the edge portion of the portion to be punched and the portion extending outside the portion to be punched from the outer periphery of the portion to be punched in the alloy ribbon.

The width of the edge portion of the portion to be punched is not specifically limited as long as no damage, such as cracking, which causes a problem in quality is caused when punched, but it is, for example, 1 mm or more in some embodiments. This is because the width equal to or more than this lower limit ensures effectively suppressing the damage, such as cracking. In some embodiments, the width of the edge portion of the portion to be punched is as small as possible. This is because increasing the proportion of the crystallized portion obtained by crystallizing the portion to be crystallized of the portion to be punched ensures improved magnetic properties of the alloy ribbon piece. This is also because, since the saturation magnetic flux density of the region neighboring the rotor core in the stator core or the region neighboring the stator core in the rotor core when the alloy ribbon piece is used for the stator core or the rotor core can be increased, the performance of the motor and the like can be improved. Here, the “width of edge portion of portion to be punched” indicates a length of the edge portion in the direction perpendicular to the outer periphery of the portion to be punched. The plane size and the shape of the portion to be punched are similar to those of the alloy ribbon piece described in the item “A. Alloy Ribbon Piece” described above, and therefore, the description is omitted here.

The “crystallization starting temperature” indicates a temperature at which the crystallization starts when the alloy ribbon is heated. The crystallization of the alloy ribbon differs depending on the constituent material and the like of the alloy ribbon, and when the constituent material is the Fe-based amorphous alloy, it means to precipitate crystal grains of fine α-iron (ferrite phase). The crystallization starting temperature differs depending on the constituent material and the like of the alloy ribbon and the heating rate, and when the heating rate is large, the crystallization starting temperature tends to be high. However, when the constituent material is the Fe-based amorphous alloy, it falls within, for example, a range of 350° C. or more and 500° C. or less. Furthermore, “to crystallize the portion to be crystallized of the portion to be punched by heating the portion to be crystallized to the temperature range equal to or more than the crystallization starting temperature” indicates to crystallize the portion to be crystallized of the portion to be punched by heating the portion to be crystallized to the temperature range equal to or more than the crystallization starting temperature and holding the portion to be crystallized in the temperature range for a period necessary for the crystallization.

While the temperature range equal to or more than the crystallization starting temperature is not specifically limited, it is a temperature range less than a compound phase precipitation starting temperature in some embodiments. This is because the precipitation of the compound phase can be suppressed. Here, the “compound phase precipitation starting temperature” indicates a temperature at which the precipitation of the compound phase starts when the alloy ribbon after the start of crystallization is further heated. The “compound phase” indicates a compound phase that is precipitated when the alloy ribbon after the start of crystallization is further heated and deteriorates the soft magnetic properties, like, for example, the compound phase of, for example, Fe—B and Fe—P when the constituent material of the alloy ribbon is the Fe-based amorphous alloy.

While the temperature range equal to or more than the crystallization starting temperature and less than the compound phase precipitation starting temperature is not specifically limited, it differs depending on the constituent material and the like of the alloy ribbon. When the constituent material is the Fe-based amorphous alloy, for example, it may be within a range equal to or more than the crystallization starting temperature and equal to or less than the crystallization starting temperature+100° C., among all, it is within a range equal to or more than the crystallization starting temperature+30° C. and equal to or less than the crystallization starting temperature+50° C. in some embodiments. This is because the temperature range equal to or more than the lower limit of these ranges ensures stably precipitating fine crystal grains. This is because the temperature range equal to or less than the upper limit of these ranges ensures suppressing the crystal grains from coarsening.

The time period to hold the portion to be crystallized of the portion to be punched in the temperature range equal to or more than the crystallization starting temperature is not specifically limited as long as the processing portion including the edge portion of the portion to be punched is not crystallized to the extent to cause the embrittlement that could cause the damage, such as cracking, which causes a problem in quality when punched. However, it differs depending on the constituent material of the alloy ribbon, the temperature range, and the like. When the constituent material is the Fe-based amorphous alloy and the temperature range is within the range equal to or more than the crystallization starting temperature and equal to or less than the crystallization starting temperature+100° C., it may be within a range of 0.5 seconds or more and 60 seconds or less, and when the temperature range is within the range of the crystallization starting temperature+30° C. or more and the crystallization starting temperature+50° C. or less, it may be within a range of one second or more and 180 seconds or less. This is because the time period equal to or more than the lower limit of these ranges ensures stably precipitating fine crystal grains. This is because the time period equal to or less than the upper limit of these ranges ensures effectively suppressing the crystallization of the processing portion.

The method of heating the portion to be crystallized of the portion to be punched to the temperature range equal to or more than the crystallization starting temperature is not specifically limited as long as it does not crystallize the processing portion including the edge portion of the portion to be punched to the extent to cause the embrittlement that could cause the damage, such as cracking, which causes a problem in quality when punched. However, for example, as illustrated in FIG. 3B and FIG. 5B, examples of the method include a method that, in a state where the alloy ribbon is placed in the atmosphere at normal temperature, the portion to be crystallized excluding the edge portion in the portion to be punched is sandwiched by the upper heating die and the lower heating die heated to a high temperature. With this method, the thin alloy ribbon efficiently radiates heat into the atmosphere from the processing portion including the edge portion of the portion to be punched. This ensures effectively suppressing the processing portion including the edge portion of the portion to be punched from embrittling by the crystallization. Accordingly, it is not necessary to actively cool the processing portion so as not to be crystallized, thereby ensuring a reduced manufacturing cost. Note that the “normal temperature” indicates a temperature that is not specifically cooled or heated, that is, a room temperature in an indoor area and an atmospheric temperature in an outdoor area, and is, for example, a temperature in a range of 20° C. 15° C. specified in JIS Z 8703.

In the heat treatment step, crystallizing the portion to be crystallized of the portion to be punched by heating the portion to be crystallized to the temperature range equal to or more than the crystallization starting temperature yields the crystallized portion including the nanocrystalline alloy. In this respect, the crystallized portion may have desired magnetic properties by precipitating fine crystal grains without substantially causing the precipitation of the compound phase or coarsening of the crystal grains.

While the nanocrystalline alloy that configures the crystallized portion is not specifically limited, it differs depending on the constituent material and the like of the portion to be crystallized. When the constituent material of the portion to be crystallized is the Fe-based amorphous alloy, for example, it is a Fe-based nanocrystalline alloy having a mixed phase structure of crystal grains of Fe or Fe alloy (for example, fine α-iron) and an amorphous phase.

While a grain diameter of the crystal grains of the crystallized portion is not specifically limited as long as the desired magnetic properties can be obtained, it differs depending on the constituent material and the like. When the constituent material is the Fe-based nanocrystalline alloy, for example, it is in a range equal to or less than 25 nm in some embodiments. This is because the coarsening deteriorates a coercivity. Note that the grain diameter of the crystal grains can be measured, for example, by a direct observation using a transmission electron microscope (TEM). The grain diameter of the crystal grains can be estimated from the coercivity or the temperature history of the crystallized portion.

The saturation magnetic flux density of the crystallized portion differs depending on the constituent material and the like, and when the constituent material is the Fe-based nanocrystalline alloy, for example, it is 1.7 T or more in some embodiments. This is because, for example, the torque of the motor and the like can be increased. The coercivity of the crystallized portion differs depending on the constituent material and the like, and when the constituent material is the Fe-based nanocrystalline alloy, for example, it may be 20 A/m or less, and among all, it is 10 A/m or less in some embodiments. This is because thus lowering the coercivity ensures, for example, effectively reducing the loss in the motor core and the like. Note that the saturation magnetic flux density and the coercivity can be measured, for example, using a vibrating sample magnetometer (VSM).

3. Punching Step

In the punching step, punching out the portion to be punched from the alloy ribbon after the heat treatment step forms the alloy ribbon piece. Specifically, punching out the portion to be punched by shearing the alloy ribbon along the outer periphery of the portion to be punched after the heat treatment step forms the alloy ribbon piece.

While the method of punching out the portion to be punched from the alloy ribbon is not specifically limited, for example, as illustrated in FIG. 4C and FIG. 6C, examples of the method include the method of performing the presswork by sandwiching the alloy ribbon by the upper pressing die and the lower pressing die.

4. Method for Manufacturing Alloy Ribbon Piece

The method for manufacturing the alloy ribbon piece includes the preparation step, the heat treatment step, and the punching step.

In the method for manufacturing the alloy ribbon piece, when the portion to be crystallized of the portion to be punched is heated to the temperature range equal to or more than the crystallization starting temperature in the heat treatment step, the processing portion including the edge portion of the portion to be punched may be heated to the temperature range lower than the crystallization starting temperature together. The residual strain of the processing portion including the edge portion of the portion to be punched can be removed. The method for manufacturing the alloy ribbon piece may further include a step of annealing the portion to be punched including the edge portion in a temperature range lower than the crystallization starting temperature before the heat treatment step. This is because removing the residual strain of the portion to be punched ensures reducing a hysteresis loss, thereby ensuring suppressing variations in a shrinkage of the portion to be punched during the crystallization and a shrinkage of the punched alloy ribbon piece by sites from occurring. Furthermore, the method for manufacturing the alloy ribbon piece may further include a step of annealing the portion to be punched including the edge portion in the temperature range lower than the crystallization starting temperature before the punching step after the heat treatment step. This is because the residual strain of the portion to be punched can be removed.

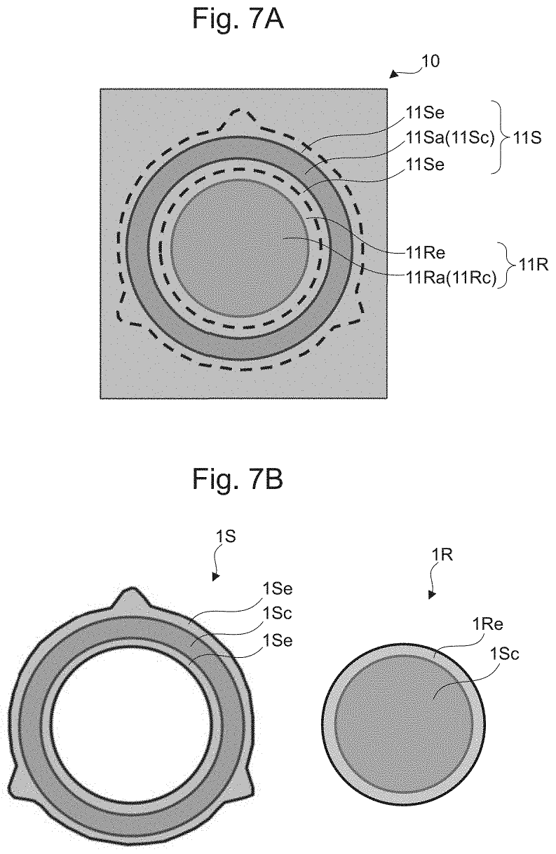

Here, another example of the method for manufacturing the alloy ribbon piece of the embodiment according to the disclosure will be described. FIG. 7A and FIG. 7B are schematic process plan views of a main part in another example of the method for manufacturing the alloy ribbon piece of the embodiment according to the disclosure.

In the method for manufacturing the alloy ribbon piece of the example, in the heat treatment step, as illustrated in FIG. 7A, the portion to be crystallized (crystallization scheduled portion) 11Sa excluding the edge portions 11Se in the portion to be punched (punching scheduled portion) 1S of the alloy ribbon piece for the stator core and a portion to be crystallized 11Ra excluding edge portions 11Re in a portion to be punched 11R of the alloy ribbon piece for the rotor core inside the portion to be punched 11S in the alloy ribbon 10 are crystallized by sandwiching them by an upper heating die and a lower heating die (not illustrated) made of copper and heated to a high temperature to heat them to the temperature range equal to or more than the crystallization starting temperature. Thus, the crystallized portion 11Sc and a crystallized portion 11Rc including the nanocrystalline alloy are provided. In the punching step, performing the presswork by sandwiching the alloy ribbon 10 by an upper pressing die and a lower pressing die (not illustrated) punches the portion to be punched 11S of the alloy ribbon piece for the stator core and the portion to be punched 11R of the alloy ribbon piece for the rotor core from the alloy ribbon 10. Accordingly, as illustrated in FIG. 7B, the alloy ribbon piece 1S for the stator core having the edge portions 1Se including the amorphous alloy and the crystallized portion 1Sc, which excludes the edge portions 1Se, including the nanocrystalline alloy and an alloy ribbon piece 1R for the rotor core having an edge portion 1Re including the amorphous alloy and a crystallized portion 1Rc, which excludes the edge portion 1Re, including the nanocrystalline alloy are formed without causing the damage, such as cracking, which causes a problem in quality.

As illustrated in FIG. 7A and FIG. 7B, the method for manufacturing the alloy ribbon piece may be a method in which the portion to be crystallized excluding the edge portion in the portion to be punched of the alloy ribbon piece for the stator core and the portion to be crystallized excluding the edge portion in the portion to be punched of the alloy ribbon piece for the rotor core inside the portion to be punched in the alloy ribbon are crystallized by heating them to the temperature range equal to or more than the crystallization starting temperature in the heat treatment step, and the portion to be punched of the alloy ribbon piece for the stator core and the portion to be punched of the alloy ribbon piece for the rotor core are punched out from the alloy ribbon in the punching step, thereby forming the alloy ribbon piece for the stator core and the alloy ribbon piece for the rotor core. This is because these alloy ribbon pieces can be efficiently produced while its material yield can be increased.

### EXAMPLES

The following further specifically describes the embodiment according to the disclosure with Examples and a Comparative Example.

### Example 1

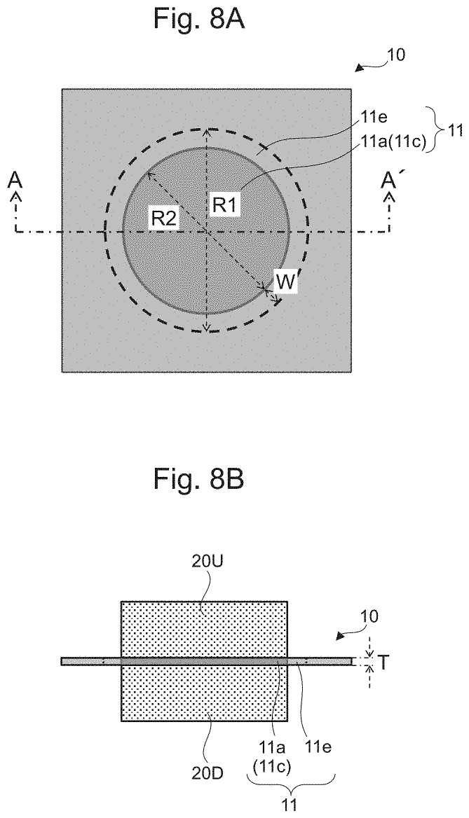

Experiments of the method for manufacturing the alloy ribbon of the embodiment were performed. The following gives a specific description. Here, FIG. 8A is a schematic plan view illustrating a heat treatment step in the experiment of the method for manufacturing the alloy ribbon, and FIG. 8B is a schematic cross-sectional view illustrating a cross-sectional surface taken along the line A-A′ in FIG. 8A.

In the experiment, first, a continuous alloy ribbon (thickness T: 0.025 mm) including a Fe-based amorphous alloy having a Fe content of 84 atomic % or more was prepared (the preparation step).

Next, as illustrated in FIG. 8A and FIG. 8B, in a state where the alloy ribbon 10 was placed in the atmosphere at normal temperature, a circular-shaped portion to be crystallized (crystallization scheduled portion) 11a (diameter R2: 20 mm) excluding an edge portion 11e (width W: 5 mm) in the portion to be punched (punching scheduled portion) 11 (diameter R1: 30 mm) of a circular-shaped alloy ribbon piece in the alloy ribbon 10 was sandwiched by the upper heating die 20U and the lower heating die 20D made of copper and heated to 460° C. to crystallize it by holding it for 30 seconds. Thus, a crystallized portion 11c including the nanocrystalline alloy was provided (the heat treatment step). In this respect, a hole was provided in advance at the center shared by the portion to be punched 11 and the portion to be crystallized 11a of the alloy ribbon piece in the alloy ribbon 10, and the center hole was used as a mark to accurately match a position of the actually heated region with a position of the portion to be crystallized 11a.

Next, the center hole was used as a mark to sandwich the alloy ribbon 10 by the upper pressing die and the lower pressing die (not illustrated) such that the position of the portion to be punched 11 of the alloy ribbon piece was accurately matched with the position of the actually punched region and perform the presswork. Thus, the portion to be punched 11 of the alloy ribbon piece was punched out from the alloy ribbon 10 to form the alloy ribbon piece (the punching step). This ensured manufacturing an alloy ribbon piece including a nanocrystalline alloy without causing the damage, such as cracking, which causes a problem in quality.

### Example 2

Except that the circular-shaped portion to be crystallized 11a (diameter R2: 24 mm) excluding the edge portion 11e (width W: 3 mm) in the portion to be punched 11 (diameter R1: 30 mm) of the circular-shaped alloy ribbon piece was crystallized by heating it in the heat treatment step, an experiment was performed similarly to that in Example 1. This ensured manufacturing an alloy ribbon piece including a nanocrystalline alloy without causing the damage, such as cracking, which causes a problem in quality.

### Example 3

Except that the circular-shaped portion to be crystallized 11a (diameter R2: 28 mm) excluding the edge portion 11e (width W: 1 mm) in the portion to be punched 11 (diameter R1: 30 mm) of the circular-shaped alloy ribbon piece was crystallized by heating it in the heat treatment step, an experiment was performed similarly to that in Example 1. This ensured manufacturing an alloy ribbon piece including a nanocrystalline alloy without causing the damage, such as cracking, which causes a problem in quality.

### Comparative Example

Except that the circular-shaped portion to be crystallized 11a (diameter R2: 29 mm) excluding the edge portion 11e (width W: 0.5 mm) in the portion to be punched 11 (diameter R1: 30 mm) of the circular-shaped alloy ribbon piece was crystallized by heating it in the heat treatment step, an experiment was performed similarly to that in Example 1. In this case, when the portion to be punched 11 of the alloy ribbon piece was punched out from the alloy ribbon 10 in the punching step, the punched out alloy ribbon piece had cracking, and therefore, an alloy ribbon piece including a nanocrystalline alloy without the damage, such as cracking, which causes a problem in quality could not be manufactured.

[Evaluation]

The results of the above-mentioned experiments are shown in Table 1 below. In Examples 1 to 3, it is considered that the reason why the alloy ribbon pieces including the nanocrystalline alloy was able to be manufactured without causing the damage, such as cracking, which causes a problem in quality is that the edge portion 11e in the portion to be punched 11 of the alloy ribbon piece was not crystallized to the extent to cause an embrittlement that could cause the damage, such as cracking, when punched. On the other hand, in the Comparative Example, it is considered that the reason of cracking in the punched out alloy ribbon piece and the failure of manufacturing the alloy ribbon piece including the nanocrystalline alloy without the damage, such as cracking, which causes a problem in quality is that the edge portion lie in the portion to be punched 11 of the alloy ribbon piece was crystallized to the extent to cause an embrittlement that could cause the damage, such as cracking, when punched.

TABLE 1

| | Portion to be | Portion to be | | Presence/ |
|---|---|---|---|---|
| | Punched | Crystallized | Edge Portion | Absence of |
| | Diameter R1 | Diameter R2 | Width W | Cracking |
| | [mm] | [mm] | [mm] | When Punched |
| Example 1 | 30 | 20 | 5 | Absent |
| Example 2 | 30 | 24 | 3 | Absent |
| Example 3 | 30 | 28 | 1 | Absent |
| Comparative | 30 | 29 | 0.5 | Present |
| Example | | | | |

While the embodiment of the present disclosure has been described in detail above, the present disclosure is not limited thereto, and can be subjected to various kinds of changes in design without departing from the spirit and scope of the present disclosure described in the claims.

All publications, patents and patent applications cited in the present description are herein incorporated by reference as they are.

What is claimed is:

1. An alloy ribbon piece comprising:
a crystallized portion excluding an edge portion, the crystallized portion including a nanocrystalline alloy obtained by crystallizing an amorphous alloy; and
the edge portion that includes an amorphous alloy.

2. The alloy ribbon piece according to claim 1,
wherein the edge portion has a width of 1 mm or more.

3. A method for manufacturing an alloy ribbon piece, comprising:
preparing an alloy ribbon including an amorphous alloy;
crystallizing a crystallization scheduled portion by heating the crystallization scheduled portion to a temperature range equal to or more than a crystallization starting temperature, the crystallization scheduled portion excluding an edge portion in a punching scheduled portion of the alloy ribbon piece in the alloy ribbon; and
forming the alloy ribbon piece by punching out the punching scheduled portion from the alloy ribbon after the crystallizing.

4. The method for manufacturing an alloy ribbon piece according to claim 3,
wherein the edge portion has a width of 1 mm or more.
